(19) United States
(12) Patent Application Publication
(10) Pub. No.: US 2006/0090579 A1
(43) Pub. Date: May 4, 2006

(54) Positive displacement pump gear

(76) Inventor: James A. Lincoln, Dallas, TX (US)

Correspondence Address: F. Lindsey Scott;Suite B, 2329 Coit Road, Plano, TX, 75075, US

(21) Appl. No.: 10/979,310

(22) Filed: Nov. 2, 2004

(51) Int. Cl. F16H 35/18

(52) U.S. Cl. 74/10.8; 417/410.4

(57) ABSTRACT

A gear for use in a positive displacement pump wherein the gear lobe outer ends are the outer ends of metallic ribs embedded in each lobe and having extended wear properties and good sealing properties.

### FIELD OF THE INVENTION

The present invention relates to a gear for use in a positive displacement pump wherein the gear has extended wear properties and good sealing properties

Rotary gear pumps and rotary gear lobe pumps consist of a housing, sometimes referred to as a case, with two gears rotating on shafts inside the case. The rotating gears create a vacuum on one side of the pump case, drawing materials into the intake side of the pump. The materials are then carried in the cavities of the lobes to the discharge side of the pump. Pressure created on the discharge side of the pump forces the materials out a discharge port.

Lobe pumps and gear pumps are both rotary gear pumps. The most commonly used distinction between the two is that in a lobe pump the gears are both turned by external shafts. In a rotary pump one gear is driven by a shaft and the other gear, referred to as a driven gear, is driven by interaction with the gear driven by the shaft. Such pumps may contain gears having from two to about 12 or more lobes. The use of from about 3 to about 8 lobes is more typical.

Rotary gear pumps and rotary gear lobe pumps are frequently used to pump substances that are difficult to pump due to thickness of the material being pumped or due to the liquids containing solids. Some substances to be pumped can also be caustic and abrasive. The gears in the pump case are subject to wear or corrosion, or both. In most cases the life of the pump is a function of the durability of the outer surfaces of the gears and inner surfaces of the case.

The choice of materials from which the gears and the case are made can determine how well the pump functions, how well the pump wears and how well the pump resists corrosion or rust. The pump cases are usually made from cast steel. Pump cases can also be made from various other materials, including stainless steel, stainless steel alloys, metallic alloys selected for specific properties, such as corrosion resistance to particular fluids, and also from rubber or plastic materials. Pump cases may also have replaceable inner wear surfaces referred to as liners or wear plates. The replaceable wear surfaces may be made from hardened steel alloys or stainless steel or other of the materials mentioned above.

The pump gears are made from various materials, including hardened steel alloys, stainless steel, other metals and metallic alloys, and rubber or plastic materials. Gears may also be made with metal inner structures and molded rubber or plastic-outer surfaces, including the lobes of the gear. The wear surfaces of this type of gear are the rubber or plastic materials of the outer surface. The abrasion resistance and the corrosion resistance are functions of the durability of the rubber or plastic material.

In some applications, steel gears are more durable, particularly with respect to abrasion, than molded rubber or plastic gears. Molded rubber or plastic gears typically seal better than steel gears and therefore can develop more pressure. Rubber gears also run quieter. Steel gears are typically more expensive to manufacture.

Accordingly, a continuing search has been made for gears which have improved abrasion and corrosion resistance and which also pump more efficiently than steel gears.

### SUMMARY OF THE INVENTION

According to the present invention, improved abrasion resistance and pumping efficiency is accomplished by a gear for use in a positive displacement pump comprising: a cylindrical body, including a coaxially positioned opening configured to mount the cylindrical body on a mating shaft; a plurality of metallic ribs equally spaced about and mounted on the cylindrical body; and, a plastic or rubber material positioned around an outside of the cylindrical body and on sides of the metallic ribs to form lobes on the gear, the lobes having their outer ends formed by the outer ends of the metallic ribs and their first and second ends formed by first and second ends of the metallic ribs.

The invention further comprises a gear for use in a positive displacement pump, the gear comprising: a cylindrical body, including a coaxially positioned opening configured to mount the cylindrical body on a mating shaft; a plurality of metallic ribs equally spaced about and mounted on the cylindrical body; and, a plastic or rubber material positioned around an outside of the cylindrical body and on sides of the metallic ribs to form lobes on the gear, the lobes having outer ends formed of the metallic ribs.

The invention also comprises a gear for use in a positive displacement pump, the gear comprising: a cylindrical body, including a coaxially positioned opening configured to mount the cylindrical body on a mating shaft; a plurality of metallic ribs equally spaced about and mounted on the cylindrical body; and, a plastic or rubber material positioned around an outside of the cylindrical body and on sides of the metallic ribs to form lobes on the gear, the lobes having exposed first and second ends of the metallic ribs on the first and second ends of the gear.

### BRIEF DESCRIPTION OF THE DRAWINGS

FIG. 1. is a schematic diagram of a prior art positive displacement lobe pump;

FIG. 2. is a schematic diagram of a prior art positive displacement lobe pump gear;

FIG. 3. is a schematic diagram of an metal skeleton for a prior art pump gear;

FIG. 4. is a cross-sectional view of a prior art gear, including a rubber or plastic lobe molded over a metal skeleton as shown in FIG. 3;

FIG. 5 is a side view of the gear shown in FIG. 4;

FIG. 6 is an end view of a gear according to the present invention; and,

FIG. 7 is a side view of the gear of FIG. 6.

### DETAILED DESCRIPTION OF THE INVENTION

In the description of the Figures, the same numbers will be used throughout to refer to the same or similar components.

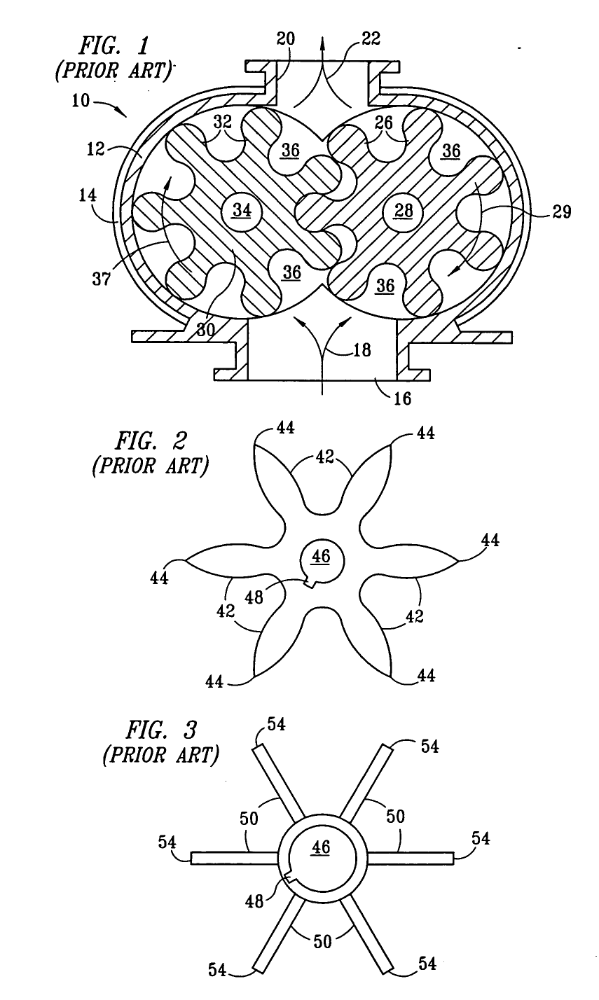

In FIG. 1 a gear pump 10 is shown. Gear pump 10 includes a pump case 12, which includes an outer cover 14 and an inlet 16 through which fluids are passed into the pump as shown by arrows 18 and an outlet 20 through which fluids are discharged from the pump as shown by arrows 22. A first gear 24 includes first gear lobes 26 and is mounted on a shaft 28 and rotates as shown by arrow 29. A second gear 30 is mounted on a shaft 36 for rotation as shown by arrow 37. The operation of such gear pumps is well known to those skilled in the art. Fluids are drawn into the pump by the creation of a vacuum at inlet 16 with the pumped material which is typically a liquid which may contain particulates and the like being passed as shown by arrows 29 and 37 to discharge 20. The discharged fluid can be at a relatively high pressure. Pressures as high as 200 psi or higher are not uncommon. A first end of the gear case is shown at 36.

In FIG. 2 a prior art gear 40 is shown. Gear 40 includes lobes 42 having lobe tips 44 and having a shaft receptacle opening 46, which typically includes a key way 48 to secure gear 40 to a shaft (not shown). Gears of this configuration are well known and can be formed of steel or metals, metal alloys or rubber or plastic or of rubber or plastic with a metal skeleton to provide greater strength to the gears. As discussed previously, the metal gears tend to be less effective at close contact to effectively seal with mating gears. Further the metal gears are very noisy and in some instance may be more vulnerable to corrosion and the like. By contrast they are more durable with respect to abrasive wear than are rubber and plastic gears. Rubber and plastic gears as noted previously are also well known.

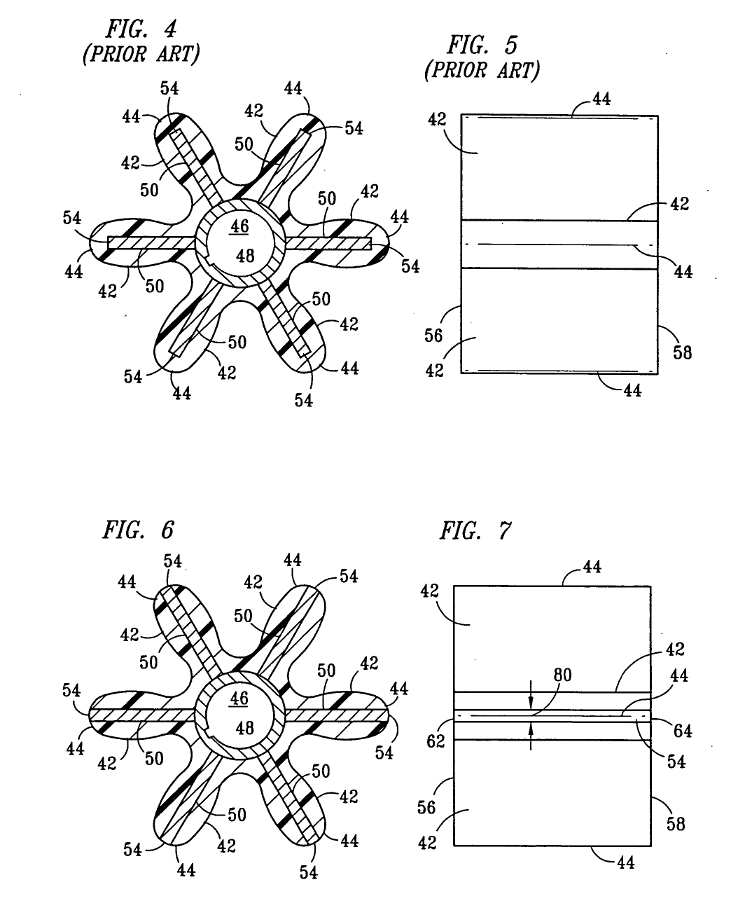

In FIG. 3 a metal skeleton for a prior art gear is shown. A shaft receptacle 46, including a key way 48, is shown in a steel cylinder 52. Steel ribs 50 are welded or otherwise joined to the outside of cylinder 52 at evenly spaced locations. This skeleton is typically then placed in a mold where a rubber or plastic material is injected into the mold to form the gear as shown in FIG. 4. The steel ribs 50 extend outwardly toward lobe tips 44 but do not extend outside and are not exposed at lobe tips 44. As shown, outer ends 54 of the ribs end well short of the tips 44 of the lobes.

FIG. 5 shows a side view of the gear of FIG. 4. First ends 56 and 58 of the gear are typically covered with the same rubber or plastic used to cover the steel cylinder and steel ribs. A tip 44 of a lobe is shown along with the sides of three lobes.

In FIG. 6 an embodiment of the present invention is shown. In this embodiment the steel ribs extend to form the outer lobe tips. The gears are produced in the same way with the gear being produced by molding or otherwise forming the rubber or plastic around the steel ribs and steel cylinder. The ribs extend outwardly as described previously and are evenly spaced around steel cylinder 52.

The lobes are formed of rubber or plastic material positioned on the outsides of the steel ribs. The outer tips 44 of the lobes as described constitute the outer ends 54 of the ribs. Accordingly, a steel surface is positioned at the outside edge of each lobe to provide increased wear while the sides of the lobes are formed of a rubber or plastic material which provides better sealing between the gears and much quieter operation.

Typically the ribs are of a thickness from about ¼ to about ⅜ of an inches and are desirably formed of a relatively hard material such as T316 stainless steel or stainless steel covered with hardened chrome coating or the like. Any suitable metal or other metal alloy could be used for the fabrication of the gears, such as hardened 17-4 stainless steel, bronze and steel. Other metals and metal alloys could also be used. Similarly, the materials used to produce a rubber or plastic coating on the lobes may be selected from materials such as buna rubber, buna-N rubber, fluoroelastomers, such as copolymers of vinylidene fluoride and hexafluoropropylene, urethane and a variety of plastic materials.

The suitable materials are by no means restricted to those cited above and any material which is suitable for the production of gears or coated gears is suitable for the practice of the present invention.

FIG. 7 is a side view of the gear of FIG. 6 is shown. The width of the rib is shown at 60 and as noted is desirably from about ¼ to about ⅜ of an inch. In the embodiment shown in FIG. 7, the ends 56 and 58 of the gear include exposed ends of the ribs in each lobe. In the embodiment shown, the sides and the ends of the ribs are exposed on respectively the ends of the gear and the outside of the lobes. It will be understood that the ends of the ribs may be covered with rubber or plastic material with only the tips of the lobes having their tips formed by the edges of the steel ribs. Similarly, it may be desirable in some instances to have the ends of the lobes covered with rubber or plastic material but have the ends of the ribs exposed on the ends of the gear. Such embodiments are well within the scope of the present invention, although it is preferred that both the ends and the tips include exposed metallic edges of the ribs.

As indicated previously, any suitable metallic material can be used to form the ribs. Stainless steel is particularly suitable since it is relatively corrosion resistant and is relatively hard. As indicated previously, hardened chrome or other hardened surfaces may be applied to the stainless steel surface within the scope of the present invention. It is preferred that both the tips of the lobes and the ends of the gear include the exposed edges or sides of the ribs in combination.

As well known to those skilled in the art, close tolerances are necessary in such pumps to ensure efficient pumping. Typically a new gear when placed in a pump is, for example, about 5.073 inches in diameter and fits into a case which is approximately 5.075 inches in diameter. Clearly, these close spacings require close tolerances for the gear. They also illustrate the necessity for close tolerances after pumping for a period of time when the gear surfaces may have been worn away.

As indicated previously, the pump cases may include replaceable linings and the like. Such variations are well known to those skilled in the art. It is also well known that positive displacement pump gears require frequent replacement. According to the present invention, extended life is achieved since the outer tips of the lobes are of steel or other suitable hard abrasion resistant metal material. Further, the gears of the present invention run much quieter than all metal gears and seal better with other gears in mating engagement as shown in FIG. 1. The gear of the present invention is more effective in pumping than the previous all metal gears. Similarly, the gear of the present invention has advantages over the rubber or plastic coated gears since the outer surfaces of the gear of the present invention are of a hard, abrasion resistant material which provides extended life. The gear of the present invention offers extended life and more efficient and quieter operation than any of the prior art gears.

While the present invention has been described by reference to certain of its preferred embodiments, it is pointed out that the embodiments described are illustrative rather than limiting in nature and that many variations and modifications are possible within the scope of the present invention. Many such variations and modifications may be considered obvious and desirable by those skilled in the art based upon a review of the foregoing description of preferred embodiments.

What is claimed is:

1. A gear for use in a positive displacement pump, the gear comprising:
a) a cylindrical body, including a coaxially positioned opening configured to mount the cylindrical body on a mating shaft;
b) a plurality of metallic ribs equally spaced about and mounted on the cylindrical body; and,
c) a plastic or rubber material positioned around an outside of the cylindrical body and on sides of the metallic ribs to form lobes on the gear, the lobes having their outer ends formed by the outer ends of the metallic ribs and their first and second ends formed by first and second ends of the metallic ribs.

2. The gear of claim 1 wherein the cylindrical body comprises a hardened metal alloy.

3. The gear of claim 1 wherein the positive displacement pump is a lobe pump or a gear pump.

4. The gear of claim 1 wherein the gear has from 2 to 12 lobes.

5. The gear of claim 1 wherein the gear has from 3 to 8 lobes.

6. The gear of claim 1 wherein the metallic ribs are of a stainless steel.

7. The gear of claim 1 wherein the metallic ribs are of a hardened stainless steel.

8. The gear of claim 1 wherein the lobes are formed for sealing contact with lobes on an interactive second gear.

9. The gear of claim 1 wherein the ribs are from about ¼ to about ⅜ inches in thickness.

10. A gear for use in a positive displacement pump, the gear comprising:
a) a cylindrical body, including a coaxially positioned opening configured to mount the cylindrical body on a mating shaft;
b) a plurality of metallic ribs equally spaced about and mounted on the cylindrical body; and,
c) a plastic or rubber material positioned around an outside of the cylindrical body and on sides of the metallic ribs to form lobes on the gear, the lobes having their outer ends formed by the outer ends of the metallic ribs.

11. The gear of claim 10 wherein the positive displacement pump is a lobe pump or a gear pump.

12. The gear of claim 10 wherein the gear has from 2 to 12 lobes.

13. The gear of claim 10 wherein the metallic ribs are of a stainless steel.

14. The gear of claim 10 wherein the lobes are formed for sealing contact with lobes on an interactive second gear.

15. The gear of claim 10 wherein the ribs are from about ¼ to about ⅜ inches in thickness.

16. A gear for use in a positive displacement pump, the gear comprising:
a) a cylindrical body, including a coaxially positioned opening configured to mount the cylindrical body on a mating shaft;
b) a plurality of metallic ribs equally spaced about and mounted on the cylindrical body; and,
c) a plastic or rubber material positioned around an outside of the cylindrical body and on sides of the metallic ribs to form lobes on the gear, the lobes having their first and second ends formed by first and second ends of the metallic ribs.

17. The gear of claim 16 wherein the positive displacement pump is a lobe pump or a gear pump.

18. The gear of claim 16 wherein the gear has from 2 to 12 lobes.

19. The gear of claim 1 wherein the metallic ribs are of a stainless steel.

20. The gear of claim 1 wherein the lobes are formed for sealing contact with lobes on an interactive second gear.
